(19) United States
(12) Patent Application Publication
(10) Pub. No.: US 2014/0169739 A1
(43) Pub. Date: Jun. 19, 2014

(54) WAVEGUIDE LENS FOR COUPLING LASER LIGHT SOURCE AND OPTICAL ELEMENT

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/961,692

(22) Filed: Aug. 7, 2013

(30) Foreign Application Priority Data
Dec. 17, 2012 (TW) 101147745

(51) Int. Cl. G02B 6/34

(52) U.S. Cl. CPC G02B 6/34
USPC 385/37

(57) ABSTRACT

A waveguide lens includes a substrate, a planar waveguide, a media grating, a first electrode, and a second electrode. The planar waveguide is formed in the substrate and configured to couple with a laser light source that emits a laser beam into the planar waveguide along an optical axis. The media grating is formed on the planar waveguide and arranged symmetrically about a widthwise central axis that is collinear with the optical axis. The second electrode covers the media grating. The first electrode is attached to the substrate and opposite to the planar waveguide. Lengths and widths of the first electrode and the second electrode are substantially equal to a length and width of the media grating, and the first electrode and the second electrode are aligned with the media grating.

### BACKGROUND

1. Technical Field

The present disclosure relates to integrated optics and, particularly, to a waveguide lens for coupling a laser light source and an optical element.

2. Description of Related Art

Lasers are used as light sources in integrated optics as the lasers have excellent directionality, as compared to other light sources. However, laser beams emitted by the lasers still have a divergence angle. As such, if the laser is directly connected to an optical element, divergent rays may not be able to enter into the optical element, decreasing light usage.

Therefore, it is desirable to provide a waveguide lens, which can overcome the above-mentioned problem.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a waveguide lens, according to an embodiment.

FIG. 2 is a cross-sectional view taken along a line II-II of FIG. 1.

FIG. 3 is a schematic view of a first media grating of the waveguide lens of FIG. 1.

### DETAILED DESCRIPTION

Embodiments of the present disclosure will be described with reference to the drawings.

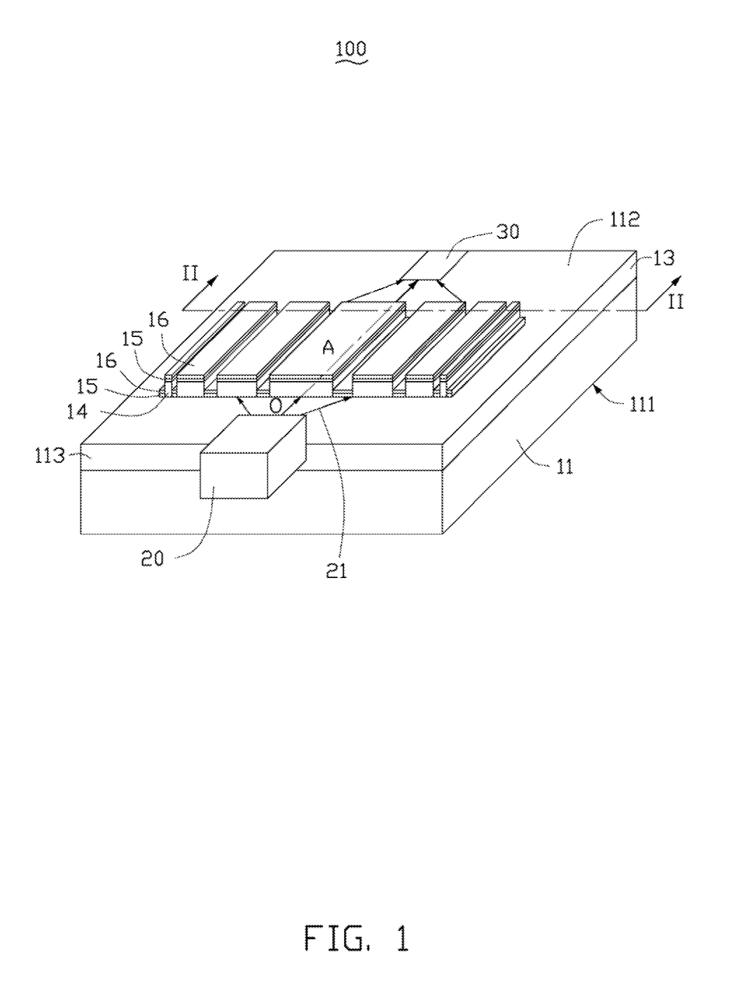

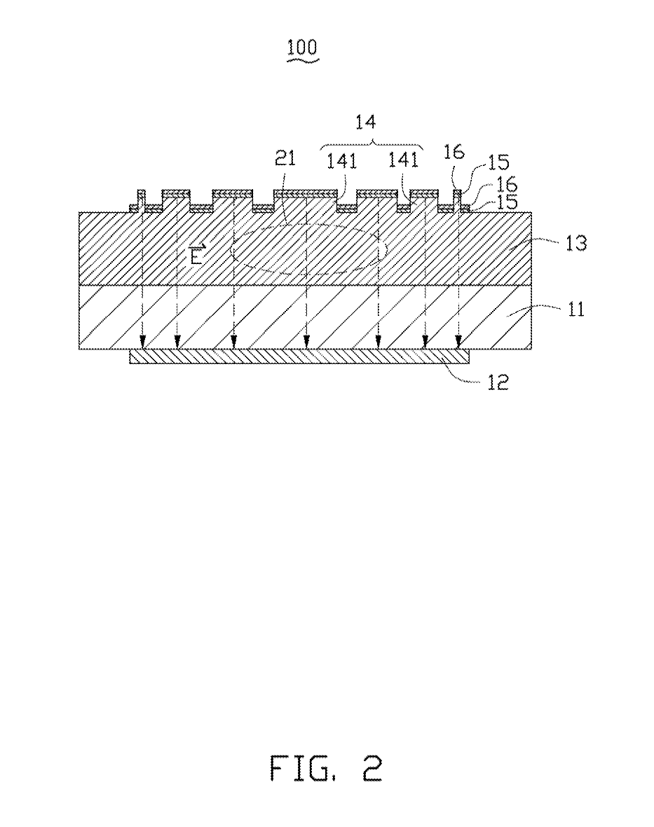

FIGS. 1 and 2 show an embodiment of a waveguide lens 100. The waveguide lens 100 includes a substrate 11, a planar waveguide 13 formed on the substrate 11, and a media grating 14 formed on the planar waveguide 13.

The substrate 11 is substantially rectangular and includes a bottom surface 111, a top surface 112, and a side surface 113 perpendicularly connecting the bottom surface 111 and the top surface 112. In this embodiment, the substrate 11 is made of lithium niobate.

The planar waveguide 13 is formed by coating titanium on the top surface 112 by, for example, sputtering, and then diffusing the titanium into the substrate 11 by, for example, a high temperature diffusing technology. That is, the planar waveguide 13 is made of lithium niobate diffused with titanium, of which an effective refractive index gradually changes when a media is loaded thereon.

The planar waveguide 13 is also rectangular, a upper surface of the planar waveguide 13 is the top surface 112, and a side surface of the planar waveguide 13 is a part of the side surface 113 and configured to couple with a laser light source 20 which emits a laser beam 21 having a divergent angle into the planar waveguide 13 substantially along an optical axis O which is substantially perpendicular to the side surface 113. The laser light source 20 is a distributed feedback laser, and is attached to a portion of the side surface 113 corresponding to the planar waveguide 13 by, for example, a die bond technology.

However, the substrate 11 and the planar waveguide 13 are not limited to this embodiment but can be changed as needed. For example, in other embodiments, the substrate 11 can be made of ceramic or plastic and the planar waveguide 13 can be made of other suitable semiconductor materials such as silicon and dioxide silicon by other suitable technologies.

The media grating 14 is formed by coating high-refractive material, such as dioxide silicon, dioxide silicon doped with boson or phosphorus, and organic compounds on the planar waveguide 13 by, for example, sputtering, and cutting the high-refractive material using, for example, a photolithography technology, to form the media grating 14.

However, the media grating 14 is not limited to this embodiment. In other embodiments, the media grating 14 can also be made of lithium niobate diffused with titanium and is formed by etching an upper part of the waveguide plate 13.

The media grating 14 can be a chirped grating and has an odd number of media strips 141. The media strips 141 are symmetrical about a widthwise central axis A of the media grating 14. The central axis A and the optical axis O are collinear. Each of the media strips 141 is rectangular and parallel with each other. In order from the widthwise central axis A to each side, widths of the media strips 141 decreases, and widths of gaps between each two adjacent media strips 141 also decreases.

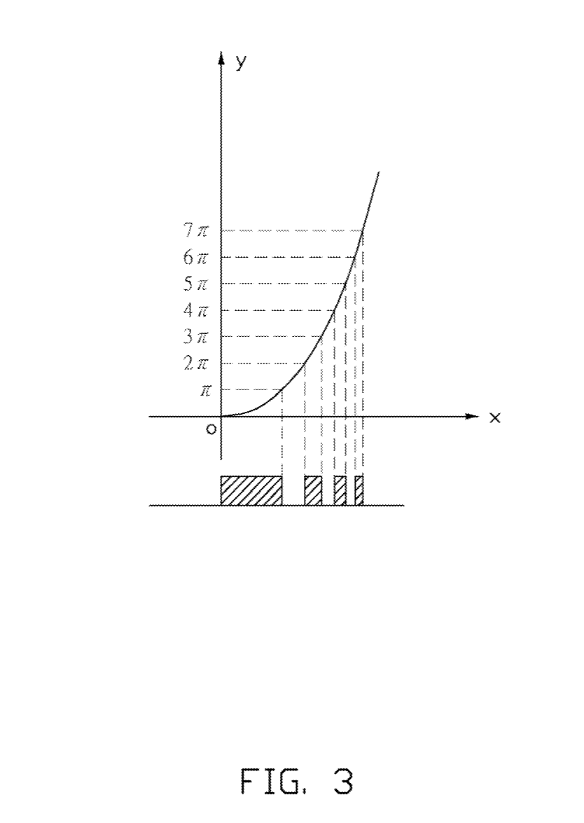

FIG. 3 shows that a coordinate system “oxy” is established, wherein the origin “o” is an intersecting point of the widthwise central axis A and a widthwise direction of the planar waveguide 13, “x” axis is the widthwise direction of the planar waveguide 13, and “y” axis is a phase shift of the laser beam 21 at a point “x”. According to wave theory of planar waveguides, y=a(1−e^{kx}^{²}), wherein x>0, a, e, and k are constants. In this embodiment, boundaries of the media strips 141 are set to conform to conditions of formulae: yₙ=a(1−e^{kx}^{ₙ}^{²}) and yₙ=nπ, wherein xₙ is the nth boundary of the media strips 141 along the “x” axis, and yₙ is the corresponding phase shift.

$${x}_{n} = \sqrt{\frac{ln ( 1 - \frac{n π}{a} )}{k}} ( {x}_{n} > 0 ) .$$

That is, The boundaries of the media strips 141 where xₙ<0 can be determined by characteristics of symmetry of the media grating 14.

The optical element 30 can be a strip waveguide, an optical fiber, or a splitter.

In operation, the media grating 14 and the planar waveguide 13 constitute a diffractive waveguide lens to converge the divergent laser beam 21 into the optical element 30. As such, usage of the laser beam 21 is increased.

In particular, the waveguide lens 100 further includes a first electrode 12 and a second electrode 16.

The first electrode 12 is substantially a rectangular sheet attached to the bottom surface 111. The first electrode 12 has a length and width that are substantially equal to a length and a width of the media grating 14 and is aligned with the media grating 14.

The second electrode 16 is a coating covering the media grating 14. A part of the second electrode 16 covers the media strips 141. The other part of the second electrode 16 infill the gaps between the media strips 141 and covers the planar waveguide 13 uncovered by the gaps. An orthogonal projection of the second electrode 16 onto the first electrode 12 coincides with the first electrode 12.

That is, the first electrode 12 and the second electrode 16 are equal to the media grating 14 in length and width and aligned with the media grating 14. As such, an electric field E generated between the first electrode 12 and the second electrode 16 passing can effectively change effective refractive index of the planar waveguide 13 and thus change effective focal length of the waveguide lens 100.

To avoid lightwaves traversing the waveguide lens from being absorbed by the second electrode 16, a buffer layer 15 is employed and sandwiched between the media grating 14 and the second electrode 16.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A waveguide lens, comprising:
a substrate having a bottom surface, a top surface opposite to the bottom surface, and a side surface perpendicularly connecting the bottom surface and the top surface;
a planar waveguide formed in the top surface and configured to couple with a laser light source that is attached to a part of the side surface corresponding to the planar waveguide and emits a laser beam into the planar waveguide along an optical axis;
a media grating formed on the top surface and arranged symmetrically about a widthwise central axis that is collinear with the optical axis;
a first electrode attached to the bottom surface; and
a second electrode covering the media grating;
wherein lengths and widths of the first electrode and the second electrode are substantially equal to a length and width of the media grating, the first electrode and the second electrode are aligned with the media grating.

2. The waveguide lens of claim 1, wherein the substrate is made of lithium niobate, ceramic, or plastic.

3. The waveguide lens of claim 1, wherein the planar waveguide is made of lithium niobate diffused with titanium, silicon, or dioxide silicon.

4. The waveguide lens of claim 1, wherein the media grating is made of a material selected from the group consisting of lithium niobate diffused with titanium, dioxide silicon, dioxide silicon doped with boson, dioxide silicon doped with phosphorus, and organic compounds.

5. The waveguide lens of claim 1, wherein the media grating is a chirped grating.

6. The waveguide lens of claim 1, wherein the media grating comprises an odd number of media strips extending along a direction that is substantially parallel with the widthwise central axis, each of the media strips is rectangular, in this order from the widthwise central axis to each widthwise side of the media grating, widths of the media strips decrease, and widths of gaps between each two adjacent media strips also decrease.

7. The waveguide lens of claim 6, wherein a coordinate axis “ox” is established, wherein the origin “o” is an intersecting point of the widthwise central axis and a widthwise direction of the planar waveguide, and “x” axis is the widthwise direction of the planar waveguide, boundaries of the media strips are set to conform condition formulae:
$${x}_{n} = \sqrt{\frac{ln ( 1 - \frac{n π}{a} )}{k}} ,$$
and xₙ>0, wherein xₙ is the nth boundary of the media strips along the “x” axis, and a and k are constants.

8. The waveguide lens of claim 1, comprising a buffer layer sandwiched between the media grating and the second electrode to avoid lightwaves traversing the waveguide lens from being absorbed by the second electrode.

9. The waveguide lens of claim 8, wherein the buffer layer is made of silicon dioxide.
